(19) United States
(12) Patent Application Publication
(10) Pub. No.: US 2008/0004985 A1
(43) Pub. Date: Jan. 3, 2008

(54) ORDER PROCESSING METHOD AND APPARATUS USING COMMUNICATION NETWORK

(75) Inventor: Shin Hyuck KANG, Seoul (KR)

Correspondence Address: THE FARRELL LAW FIRM, P.C., 333 EARLE OVINGTON BOULEVARD, SUITE 701, UNIONDALE, NY, 11553, US

(73) Assignee: SAMSUNG ELECTRONICS CO., LTD., Suwon-si (KR)

(21) Appl. No.: 11/768,618

(22) Filed: Jun. 26, 2007

(30) Foreign Application Priority Data
Jun. 28, 2006 (KR) 10-2006-0058389

(51) Int. Cl. G06Q 30/00; G06F 17/30

(52) U.S. Cl. 705/26

(57) ABSTRACT

An order processing method and apparatus using a communication network are disclosed. The method includes storing service article information of business establishments in a database, receiving an information request message from a mobile terminal placing an order, which message is associated with an identification tag read by the mobile terminal, extracting a service article list of a business establishment indicated by the message from the database, creating an information response message including the extracted list, transmitting the information response message to the mobile terminal, receiving a purchase order message including order information based on the service article list from the mobile terminal, and forwarding the purchase order message to an order display terminal installed in the business establishment indicated by the information request message.

### PRIORITY

This application claims priority to an application entitled “ORDER PROCESSING METHOD AND APPARATUS USING COMMUNICATION NETWORK” filed in the Korean Intellectual Property Office on Jun. 28, 2006 and assigned Serial No. 2006-0058389, the contents of which are incorporated herein by reference.

### BACKGROUND OF THE INVENTION

1. Field of the Invention

The present invention relates generally to order processing and, more particularly, to an order processing method and apparatus using a communication network.

2. Description of the Related Art

In a restaurant or café type of setting, customers typically order food via restaurant employees, who routinely move from table to table to take orders.

However, there are instances when a customer may have to wait for an employee to come for placing an order, or an employee may have to wait for a customer to get ready to order. At busy mealtimes, employees are under pressure to work quickly with a rush of orders, and some orders may be served out of order or may be unserved.

### SUMMARY OF THE INVENTION

The present invention has been made in view of the above problems, and provides an order processing method and apparatus that enable customer-driven order processing.

The present invention also provides an order processing method and apparatus that enable rapid and systematic order processing without direct interaction between customers and employees.

In accordance with an exemplary embodiment of the present invention, there is provided an order processing method including storing service article information of business establishments in an establishment information database, receiving an information request message from a mobile terminal placing an order, wherein the information request message is associated with an identification tag read by the mobile terminal, extracting a service article list of a business establishment indicated by the information request message from the establishment information database, creating an information response message containing the extracted service article list, transmitting the information response message to the mobile terminal, receiving a purchase order message containing order information based on the service article list from the mobile terminal, and forwarding the purchase order message to an order display terminal installed in the business establishment indicated by the information request message.

The identification tag is a bar code or Radio Frequency IDentification (RFID) tag including identification information of a business establishment.

The identification tag may further include identification information of a table in the business establishment.

The purchase order message contains the table identification information and an order breakdown.

The establishment information database stores establishment records, each of which includes an identification code, name, contact address, location and service article list of a business establishment.

The service article list may include information regarding categories, codes, names and prices of service articles.

The information request message contains identification information of the mobile terminal, identification information of an establishment information server managing the establishment information database and identification information of a business establishment indicated by the identification tag.

The purchase order message contains identification information of a mobile terminal placing an order and an order breakdown.

In accordance with an exemplary embodiment of the present invention, there is provided a mobile terminal including a communication unit for communicating, through a mobile communication network, with an establishment information server storing and managing service article information of business establishments, a tag reader for reading an identification tag, a control unit for creating, upon reading of an identification tag by the tag reader, an information request message for a business establishment indicated by the read identification tag, transmitting the created information request message through the communication unit to the establishment information server, and receiving in return an information response message containing a service article list of the business establishment from the establishment information server, and for creating a purchase order message containing order information based on the service article list, and transmitting the created purchase order message through the communication unit to the establishment information server, a display unit for displaying the service article list in the information response message under the control of the control unit, and an input unit for inputting customer order information based on the displayed service article list, and sending the customer order information to the control unit.

The tag reader reads a bar code or RFID tag that includes identification information of a business establishment and of a table in the business establishment.

The control unit creates a purchase order message containing table identification information and an order breakdown.

The control unit creates an information request message that contains identification information of the mobile terminal, the establishment information server and a business establishment indicated by the read identification tag.

The control unit creates a purchase order message containing identification information of the mobile terminal and an order breakdown.

The display unit displays names and prices of service articles in the service article list.

In accordance with an exemplary embodiment of the present invention, there is provided an establishment information server including an establishment information database for storing service article information of business establishments, a first communication unit for communicating with a mobile terminal placing an order, a second communication unit for communicating with an order display terminal installed in a business establishment capable of processing the order, and a control unit for creating, upon reception of an information request message through the first communication unit, an information response message, and transmitting the created information response message through the first communication unit, and for forwarding, upon reception of a purchase order message through the first communication unit, the purchase order message through the second communication unit.

The establishment information database stores establishment records, each of which includes an identification code, name, contact address, location and service article list of a business establishment.

The service article list includes information regarding categories, codes, names and prices of service articles.

The first communication unit communicates with the mobile terminal through a mobile communication network.

The second communication unit communicates with the order display terminal through a wired or wireless communication network.

The control unit extracts, upon reception of the information request message, a service article list of a business establishment indicated by the information request message and creates an information response message containing the extracted service article list.

In accordance with an exemplary embodiment of the present invention, there is provided an order display terminal, installed in a business establishment, including a communication unit for communicating with an establishment information server for order processing, wherein the establishment information server stores and manages service article information of business establishments and communicates with a mobile terminal placing an order, a control unit for extracting, upon reception of a purchase order message through the communication unit from the mobile terminal, an order breakdown from the received purchase order message, and a display unit for displaying the extracted order breakdown under the control of the control unit.

The control unit extracts customer identification information from the received purchase order message and controls the display unit to display the extracted customer identification information together with the order breakdown.

The customer identification information is a phone number of the mobile terminal, or alternatively, is a serial number of a table in the business establishment.

### BRIEF DESCRIPTION OF THE DRAWINGS

The above and other objects, features and advantages of the present invention will be more apparent from the following detailed description in conjunction with the accompanying drawings, in which:

FIG. 1 illustrates an order processing method according to the present invention;

FIG. 2 illustrates recognition of an identification tag according to the present invention;

FIGS. 3A and 3B illustrate a barcode representing establishment information according to the present invention;

FIG. 4 illustrates a format of an information request message for a business establishment according to the present invention;

FIG. 5 illustrates a format of an information response message according to the present invention;

FIG. 6 is a screen representation illustrating a list of articles available to order according to the present invention;

FIGS. 7A and 7B illustrate formats of a first purchase order message and second purchase order message according to the present invention;

FIG. 8 is a screen representation illustrating an order breakdown according to the present invention;

FIG. 9 illustrates a mobile terminal according to the present invention;

FIG. 10 illustrates an establishment information server according to the present invention;

FIG. 11 illustrates an establishment record in an establishment information database according to the present invention; and

FIG. 12 illustrates an order display terminal according to the present invention.

### DETAILED DESCRIPTION OF THE PREFERRED EMBODIMENTS

Hereinafter, preferred embodiments of the present invention are described in detail with reference to the accompanying drawings. The same reference symbols identify the same or corresponding elements in the drawings. Detailed descriptions of constructions or processes known in the art may be omitted for the sake of clarity and conciseness.

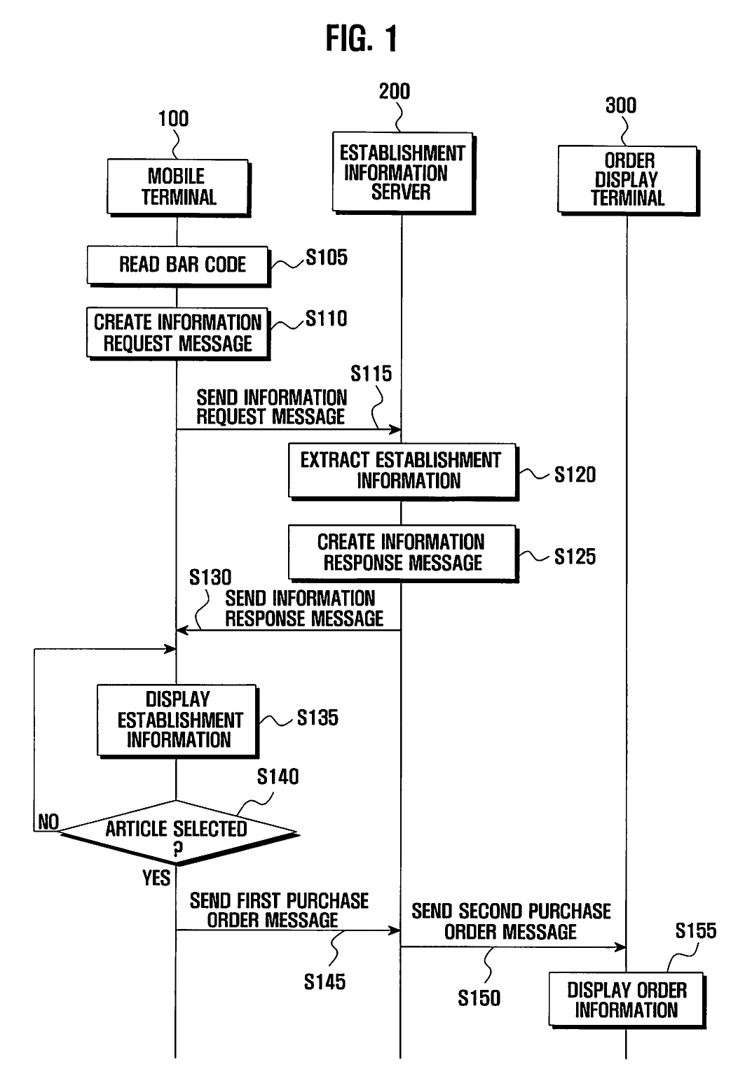

FIG. 1 illustrates an order processing method according to the present invention. Order processing is performed using an order processing apparatus that includes a mobile terminal 100 for placing an order, an establishment information server 200 for storing and managing information regarding service articles of business establishments, and an order display terminals 300 for displaying order information and installed at a business establishment capable of processing the order.

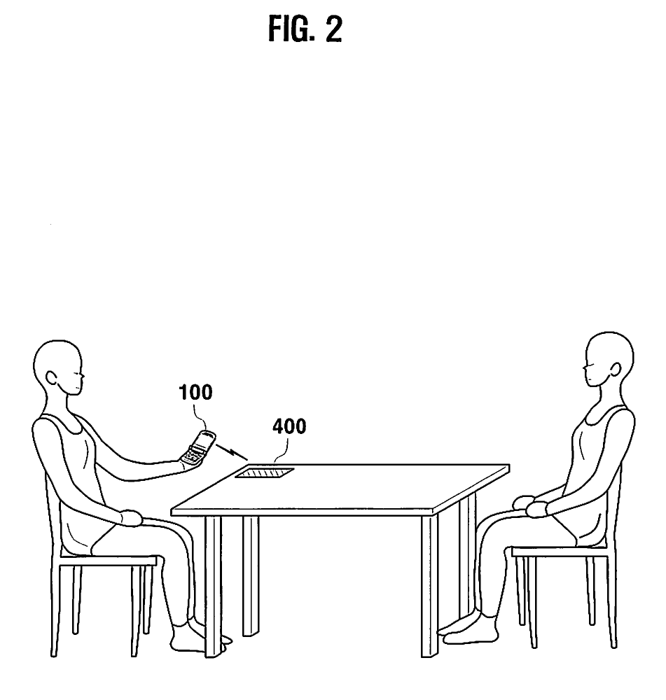

Referring to FIG. 1, the mobile terminal 100 having a bar code scanner reads a bar code (S105). The bar code is an identification tag for identifying a business establishment, and is printed on a table in an establishment, as illustrated in FIG. 2, for a visiting customer. The bar code enables a visiting customer to place an order using the mobile terminal 100.

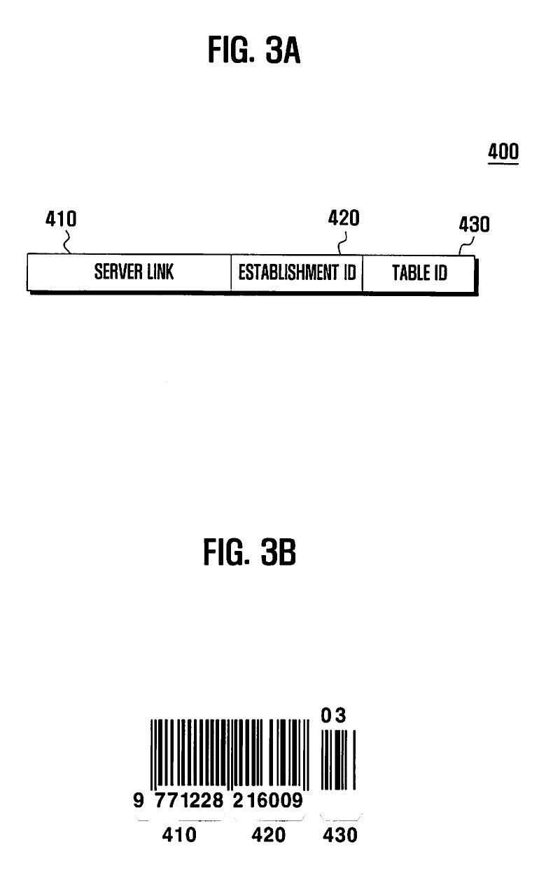

FIG. 3A illustrates a format of a bar code 400, and FIG. 3B illustrates a printed bar code. The bar code 400 includes a server link field 410, establishment ID field 420 and table ID field 430. The server link field 410 stores contact information of the establishment information server 200 such as a phone number. The mobile terminal 100 uses the contact information to access the establishment information server 200 through a mobile communication network. The establishment ID field 420 stores identification information of a business establishment that has printed the bar code 400. The table ID field 430 stores the identification number of a table in the establishment.

The bar code 400 is printed on a table in an establishment as illustrated in FIG. 2. Alternatively, the bar code 400 can be printed on an advertisement leaflet. The table ID field 430 of the bar code 400 printed on a leaflet may be empty or contain information on location at which the leaflet is distributed instead of a table identification number. Thus, a customer can place a home delivery order or make a reservation using a mobile terminal capable of reading a bar code 400 printed on a leaflet.

Referring back to FIG. 1, after scanning the bar code, the mobile terminal 100 creates an information request message using information present in the server link field 410 and establishment ID field 420 of the bar code in step S110, and transmits the created information request message to the establishment information server 200 in step S115.

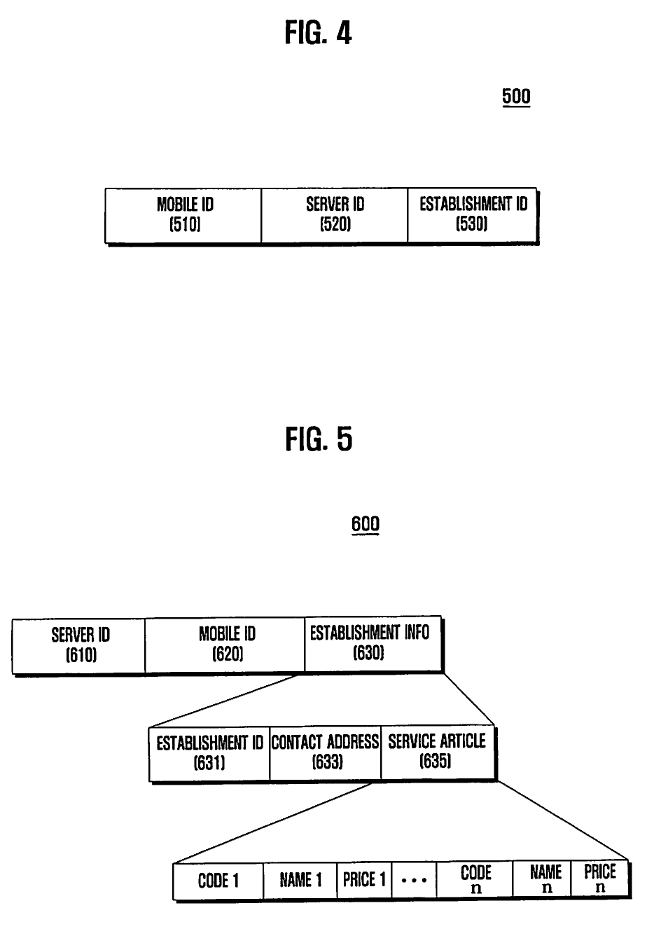

FIG. 4 illustrates a format of an information request message 500, which includes a mobile ID field 510, server ID field 520 and establishment ID field 530. The mobile ID field 510 stores identification information of the mobile terminal 100 (a source), the server ID field 520 stores identification information of the establishment information server 200 (a destination) and the establishment ID field 530 stores the establishment identification information obtained from the bar code.

When the information request message from the mobile terminal 100 is received, the establishment information server 200 extracts establishment information corresponding to the received information request message from an establishment information database in step S120. The establishment information may be information on service articles deliverable by a business establishment indicated by the received information request message. The establishment information server 200 creates an information response message containing the extracted establishment information in step S125, and transmits the created information response message to the mobile terminal 100 in step S130.

FIG. 5 illustrates a format of an information response message 600, and includes a server ID field 610, mobile ID field 620 and establishment INFO field 630. The server ID field 610 stores identification information of the establishment information server 200 (a source), the mobile ID field 620 stores identification information of the mobile terminal 100 (a destination) and the establishment INFO field 630 stores establishment information extracted from the establishment information database. The establishment INFO field 630 includes an establishment ID field 631, contact address field 633 and service article field 635. The service article field 635 stores codes, names and prices of service articles, and may further store category information of service articles.

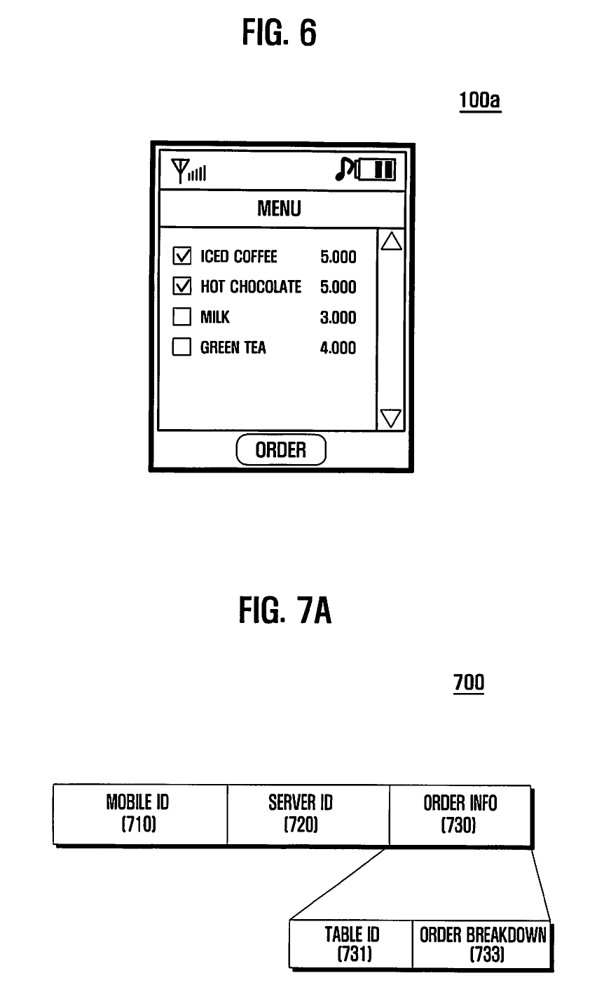

When the information response message from the establishment information server 200 is received, the mobile terminal 100 displays establishment information present in the received information response message on a display screen 100a, as illustrated in FIG. 6 in step S135. Referring to FIG. 6, the mobile terminal 100 displays service articles and their prices on a display screen 100a. When the customer selects at least one service article in step S140, the mobile terminal 100 creates a first purchase order message using the customer selection and transmits the created first purchase order message to the establishment information server 200 in step S145. For example, as illustrated in FIG. 6, if the customer has selected service articles ‘iced coffee’ and ‘hot chocolate’, the first purchase order message includes information regarding the selected service articles ‘iced coffee’ and ‘hot chocolate’.

When the first purchase order message is received, the establishment information server 200 creates a second purchase order message on the basis of the first purchase order message, and transmits the created second purchase order message to the order display terminal 300 installed in the requested establishment in step S150. The second purchase order message has a source and destination different from corresponding ones of the first purchase order message.

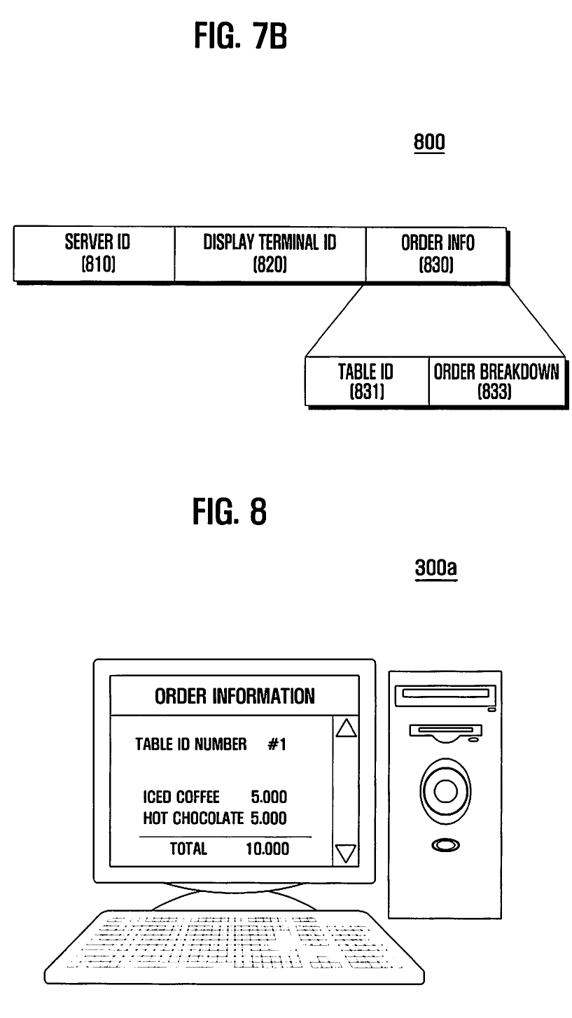

FIGS. 7A and 7B illustrate formats of a first purchase order message 700 and second purchase order message 800. The first purchase order message 700 includes a mobile ID field 710, server ID field 720 and order INFO field 730. The mobile ID field 710 stores identification information of the mobile terminal 100 (a source), the server ID field 720 stores identification information of the establishment information server 200 (a destination) and the order INFO field 730. The order INFO field 730 includes a table ID field 731 and order breakdown field 733. For example, as illustrated in FIG. 6, if the customer has selected service articles ‘iced coffee’ and ‘hot chocolate’, the order breakdown field 733 includes code and price information of the selected service articles ‘iced coffee’ and ‘hot chocolate’. Referring to FIG. 7B, the second purchase order message 800 includes a server ID field 810, display terminal ID field 820 and order INFO field 830. The server ID field 810 stores identification information of the establishment information server 200 (a source) and the display terminal ID field 820 stores identification information of an order display terminal 300 (a destination). The order INFO field 830 includes a table ID field 831 and order breakdown field 833, as in a first purchase order message 700.

Referring back to FIG. 1, when the second purchase order message from the establishment information server 200 is received, the order display terminal 300 displays order information present in the received second purchase order message as illustrated in FIG. 8 in step S155. The order information displayed in FIG. 8 corresponds to the service articles selected in FIG. 6 by the customer.

In FIG. 1, the mobile terminal 100 and establishment information server 200 communicate with each other through a mobile communication network, and the establishment information server 200 and order display terminal 300 communicate with each other through a wired network such as the Internet or a private network or through a wireless network.

In addition, although a bar code is used as an identification tag in FIG. 1, other contactless identification tags such as an RFID tag may also be used as the identification tag.

As described above, the present invention enables rapid and systematic order processing without direct interaction between customers and employees.

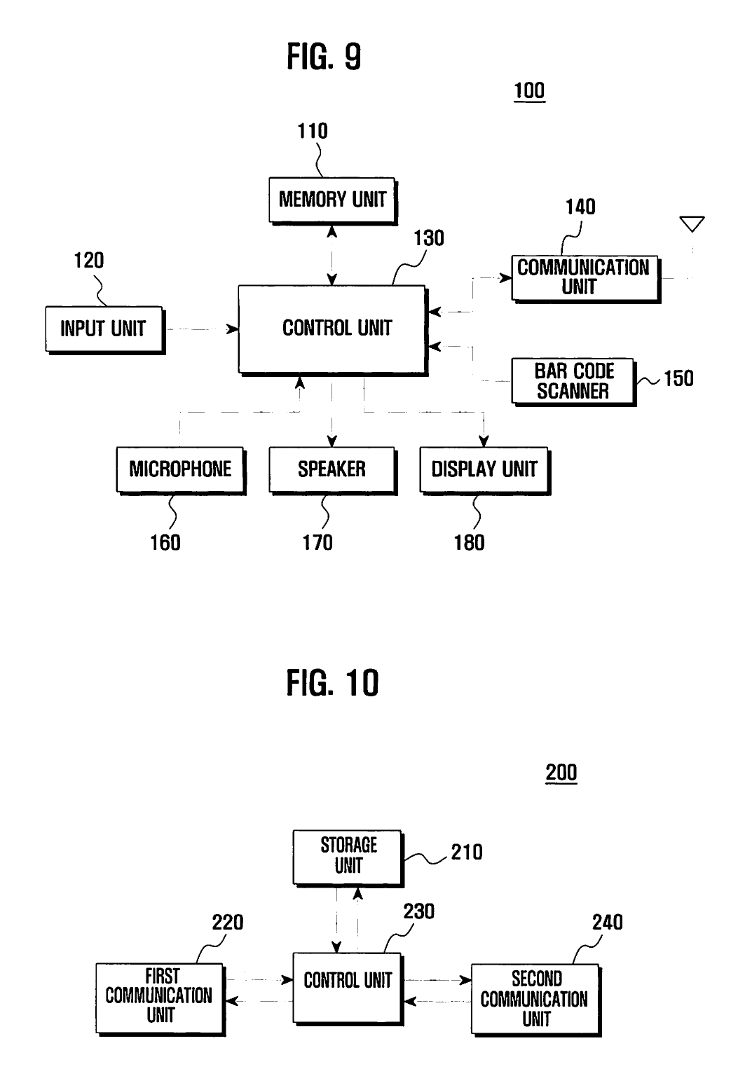

FIG. 9 illustrates a configuration of a mobile terminal 100 according to the present invention. Referring to FIG. 9, the mobile terminal 100 includes a memory unit 110, input unit 120, control unit 130, communication unit 140, bar code scanner 150, microphone 160, speaker 170 and display unit 180.

The memory unit 110 stores system and application programs for operating the mobile terminal 100 and data associated with the programs.

The input unit 120 provides a user interface for controlling operations of the mobile terminal 100, includes a keypad, and sends an input key signal to the control unit 130. In particular, when the customer selects a service article to be ordered in a service article list displayed on the display unit 180, the input unit 120 sends a key signal corresponding to the customer selection to the control unit 130.

The control unit 130 controls operations of the mobile terminal 100 on the basis of key signals input through the input unit 120 and programs stored in the memory unit 110. In particular, when a bar code is recognized by the bar code scanner 150, the control unit 130 creates an information request message corresponding to the establishment information in the bar code, and controls the communication unit 140 to transmit the created information request message through a mobile communication network to an establishment information server that stores and manages information regarding service articles of business establishments. An information request message is described in connection with FIG. 4.

When an information response message from the establishment information server is received, the control unit 130 controls the display unit 180 to display a service article list corresponding to the received information response message. When the customer selects at least one service article in the service article list, the control unit 130 creates a first purchase order message based on the customer selection, and controls the communication unit 140 to transmit the created first purchase order message to the establishment information server. A first purchase order message is described in connection with FIG. 7A.

The communication unit 140 provides a communication interface to, in particular, a mobile communication network, and communicates with the establishment information server managing service article information through the mobile communication network, under the control of the control unit 130.

The bar code scanner 150 reads a bar code identifying a business establishment. The bar code is an identification tag, and includes identification information of an establishment and a table in the establishment. If the bar code were replaced with an RFID tag, the bar code scanner 150 would be replaced with an RFID tag reader.

The microphone 160 collects an acoustic signal such as a voice signal, and sends the collected acoustic signal to the control unit 130. The speaker 170 outputs an acoustic signal from the control unit 130.

The display unit 180 displays a visual signal under the control of the control unit 130, and particularly displays a service article list associated with an information response message. The service article list may include names and prices of service articles available from a business establishment.

FIG. 10 illustrates an establishment information server 200 according to the present invention. Referring to FIG. 10, the establishment information server 200 includes a storage unit 210, first communication unit 220, control unit 230 and second communication unit 240.

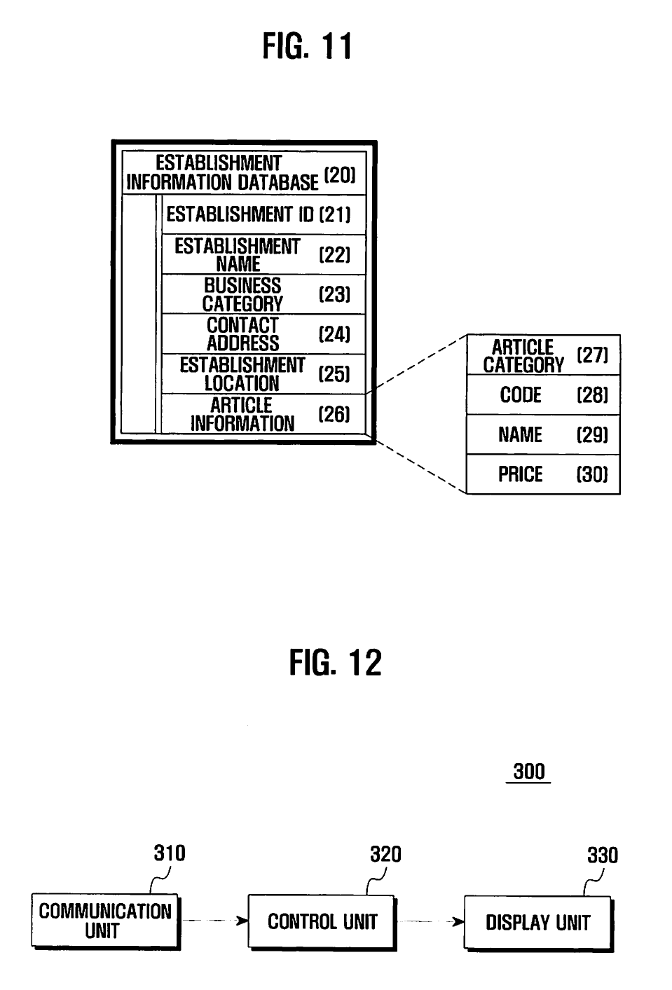

The storage unit 210 stores information regarding service articles for establishments as an establishment information database 20. A format of an establishment record in the establishment information database 20 is illustrated in FIG. 11. An establishment record includes an establishment ID field 21, establishment name field 22, business category field 23, contact address field 24, establishment location field 25 and article information field 26. The article information field 26 is created for each service article, and includes an article category field 27, code field 28, name field 29 and price field 30. The first communication unit 220 communicates with a mobile terminal of a customer through a mobile communication network. The first communication unit 220 receives an information request message for a particular establishment from a mobile terminal, and sends, in return, an information response message to the mobile terminal. In addition, the first communication unit 220 receives a first purchase order message from the mobile terminal, and sends the received first purchase order message to the control unit 230.

The second communication unit 240 communicates, through a wired or wireless communication network, with an order display terminal installed in a business establishment capable of processing an order. The second communication unit 240 sends a second purchase order message, associated with a first purchase order message, from the control unit 230 to the order display terminal.

The control unit 230 extracts, upon reception of an information request message through the first communication unit 220, service article information corresponding to the received information request message from the storage unit 210. Then, the control unit 230 creates an information response message using the extracted service article information, and sends the information response message through the first communication unit 220 to a mobile terminal.

The control unit 230 creates, upon reception of a first purchase order message through the first communication unit 220, a second purchase order message, and sends the second purchase order message through the second communication unit 240 to an order display terminal.

FIG. 12 illustrates an order display terminal 300 according to the present invention. Referring to FIG. 12, the order display terminal 300 includes a communication unit 310, control unit 320 and display unit 330.

The communication unit 310 communicates with the establishment information server 200 of FIG. 10 through a wired or wireless communication network.

The control unit 320 extracts, upon reception of a second purchase order message through the communication unit 310, an order breakdown from the second purchase order message, and outputs the extracted order breakdown to the display unit 330. The control unit 320 also extracts customer identification information such as a table number and phone number from the second purchase order message, and outputs the extracted customer identification information to the display unit 330 together with the order breakdown.

The display unit 330 displays order information under the control of the control unit 320.

As apparent from the above description, the present invention provides an order processing method and apparatus wherein order processing is performed using a communication network without direct interaction between customers and employees. Thereby, rapid and systematic order processing is possible in a customer-driven manner.

While preferred embodiments of the present invention have been shown and described in this specification, it will be understood by those skilled in the art that various changes or modifications of the embodiments are possible without departing from the spirit and scope of the invention as defined by the appended claims.

What is claimed is:

1. An order processing method comprising:
storing service article information of business establishments in an establishment information database;
receiving an information request message from a mobile terminal placing an order, wherein the information request message is associated with an identification tag read by the mobile terminal;
extracting a service article list of a business establishment indicated by the information request message from the establishment information database;
creating an information response message including the extracted service article list;
transmitting the information response message to the mobile terminal;
receiving a purchase order message including order information based on the service article list from the mobile terminal; and
forwarding the purchase order message to an order display terminal installed in the business establishment indicated by the information request message.

2. The order processing method of claim 1, wherein the identification tag is a bar code comprising identification information of a business establishment.

3. The order processing method of claim 1, wherein the identification tag is a Radio Frequency IDentification (RFID) tag comprising identification information of a business establishment.

4. The order processing method of claim 2, wherein the identification tag further comprises identification information of a table in the business establishment.

5. The order processing method of claim 4, wherein the purchase order message includes the table identification information and an order breakdown.

6. The order processing method of claim 1, wherein the establishment information database stores establishment records, each of which comprises an identification code, name, contact address, location and service article list of a business establishment.

7. The order processing method of claim 6, wherein the service article list comprises information regarding categories, codes, names and prices of service articles.

8. The order processing method of claim 1, wherein the information request message is received through a mobile communication network.

9. The order processing method of claim 1, wherein the information request message includes identification information of each of the mobile terminal, an establishment information server managing the establishment information database, and a business establishment indicated by the identification tag.

10. The order processing method of claim 1, wherein the information response message is transmitted through a mobile communication network.

11. The order processing method of claim 1, wherein the purchase order message includes identification information of a mobile terminal placing an order, and an order breakdown.

12. The order processing method of claim 1, wherein the purchase order message is received through a mobile communication network.

13. The order processing method of claim 1, wherein the purchase order message is forwarded through a wired or wireless communication network.

14. A mobile terminal comprising:
a communication unit for communicating, through a mobile communication network, with an establishment information server storing and managing service article information of business establishments;
a tag reader for reading an identification tag;
a control unit for creating, upon reading of an identification tag by the tag reader, an information request message for a business establishment indicated by the read identification tag, transmitting the created information request message through the communication unit to the establishment information server, and receiving in return an information response message including a service article list of the business establishment from the establishment information server, and for creating a purchase order message including order information based on the service article list, and transmitting the created purchase order message through the communication unit to the establishment information server;
a display unit for displaying the service article list in the information response message under the control of the control unit; and
an input unit for inputting customer order information based on the displayed service article list, and sending the customer order information to the control unit.

15. The mobile terminal of claim 14, wherein the tag reader reads a bar code comprising identification information of a business establishment.

16. The mobile terminal of claim 15, wherein the bar code further comprises identification information of a table in the business establishment.

17. The mobile terminal of claim 14, wherein the tag reader reads a Radio Frequency IDentification (RFID) tag comprising identification information of a business establishment.

18. The mobile terminal of claim 17, wherein the RFID tag further comprises identification information of a table in the business establishment.

19. The mobile terminal of claim 14, wherein the control unit creates a purchase order message including table identification information and an order breakdown.

20. The mobile terminal of claim 14, wherein the control unit creates an information request message that includes identification information of each of the mobile terminal, the establishment information server, and a business establishment indicated by the read identification tag.

21. The mobile terminal of claim 14, wherein the control unit creates a purchase order message including identification information of the mobile terminal and an order breakdown.

22. The mobile terminal of claim 14, wherein the display unit displays names and prices of service articles in the service article list.

23. An establishment information server comprising:
an establishment information database for storing service article information of business establishments;
a first communication unit for communicating with a mobile terminal placing an order;
a second communication unit for communicating with an order display terminal installed in a business establishment capable of processing the order; and
a control unit for creating, upon reception of an information request message through the first communication unit, an information response message, and transmitting the created information response message through the first communication unit, and for forwarding, upon reception of a purchase order message through the first communication unit, the purchase order message through the second communication unit.

24. The establishment information server of claim 23, wherein the establishment information database stores establishment records, each of which comprises an identification code, name, contact address, location and service article list of a business establishment.

25. The establishment information server of claim 24, wherein the service article list comprises information regarding categories, codes, names and prices of service articles.

26. The establishment information server of claim 23, wherein the first communication unit communicates with the mobile terminal through a mobile communication network.

27. The establishment information server of claim 23, wherein the second communication unit communicates with the order display terminal through a wired or wireless communication network.

28. The establishment information server of claim 23, wherein the control unit extracts, upon reception of the information request message, a service article list of a business establishment indicated by the information request message, and creates an information response message including the extracted service article list.

29. An order display terminal, installed in a business establishment, comprising:
a communication unit for communicating with an establishment information server for order processing, wherein the establishment information server stores and manages service article information of business establishments and communicates with a mobile terminal placing an order;
a control unit for extracting, upon reception of a purchase order message through the communication unit from the mobile terminal, an order breakdown from the received purchase order message; and
a display unit for displaying the extracted order breakdown under the control of the control unit.

30. The order display terminal of claim 29, wherein the control unit extracts customer identification information from the received purchase order message and controls the display unit to display the extracted customer identification information together with the order breakdown.

31. The order display terminal of claim 30, wherein the customer identification information is a phone number of the mobile terminal.

32. The order display terminal of claim 30, wherein the customer identification information is a serial number of a table in the business establishment.
